(19) United States
(12) Patent Application Publication
(10) Pub. No.: US 2016/0318394 A1
(43) Pub. Date: Nov. 3, 2016

(54) LOWER STRUCTURE OF DRIVER'S COMPARTMENT AND METHOD FOR DETERMINING PEDAL SLANT ANGLES

(71) Applicant: MAZDA MOTOR CORPORATION, Hiroshima (JP)

(72) Inventors: Tomonori OHTSUBO, Hiroshima (JP); Hiroki UEMURA, Hiroshima (JP); Yoji YATSUSHIRO, Hiroshima (JP); Asami IWAMOTO, Hiroshima (JP); Shingo KUNIHIRO, Hiroshima (JP); Masayoshi HORIUE, Hiroshima (JP)

(73) Assignee: MAZDA MOTOR CORPORATION, Hiroshima (JP)

(21) Appl. No.: 15/211,664

(22) Filed: Jul. 15, 2016

Related U.S. Application Data
(62) Division of application No. 13/368,180, filed on Feb. 7, 2012.

(30) Foreign Application Priority Data
Mar. 18, 2011 (JP) 2011-060731

(51) Int. Cl. B60K 26/02; B60T 7/04

(52) U.S. Cl. CPC B60K 26/02; B60T 7/04; B60K 2026/026

(57) ABSTRACT

A pressing face of an acceleration pedal, which is formed to slant such that a front portion thereof is positioned at a higher level than a rear portion thereof, is located in front of a pressing face of a brake pedal, which is formed to slant such that a front portion thereof is positioned at a higher level than a rear portion thereof. A slant angle of the pressing face of the acceleration pedal relative to a horizontal face is different from a slant angle of the pressing face of the brake pedal relative to the horizontal face in a side view. Accordingly, a lower structure of a driver's compartment which can improve the operation of the acceleration and brake pedals can be provided.

### CROSS-REFERENCE TO RELATED APPLICATIONS

The present application is a Divisional of and claims priority to U.S. patent application Ser. No. 13/368,180 filed Feb. 7, 2012, which claims priority from Japanese Patent Application No. 2011-060731 filed Mar. 18, 2011, the contents of which are all herein incorporated by reference in their entirety.

### BACKGROUND OF THE INVENTION

The present invention relates to a lower structure of a driver's compartment of a vehicle which comprises brake and acceleration pedals to be pressed by an operational foot of a driver seated in the driver's seat and a floor portion on which a heel portion of the operational foot is placed, and a method for determining pedal slant angles of the acceleration and brake pedals of plural kinds of vehicle which are respectively equipped with the above-described lower structure.

The pedal structure and the like have been developed to improve the operation of the brake and acceleration pedals.

Japanese Patent Laid-Open Publication No. 2009-90838, for example, discloses the pedal structure in which the pressing face of the brake pedal to be pressed by the operational foot of the driver is supported via a linkage mechanism so as to move forward in parallel when the driver presses the brake pedal. According to this structure, an angle of the ankle of the operational foot can be maintained at a constant angle, so that any damages caused to the ankle can be reduced properly and the pressing force of the operational foot can be added to the brake pedal efficiently.

Herein, it has been desired that the operation of each of the above-described acceleration and brake pedals is improved as well as the pressing change between these pedals is conducted within a properly short period. That is, if it takes too long to conduct the pressing change between the pedals, the operation of the acceleration pedal and the brake pedal may deteriorate, so that there is a concern that the vehicle driving condition may be inappropriate. Therefore, the period of the pressing change between the pedals needs to be shortened.

### SUMMARY OF THE INVENTION

The present invention has been devised in view of the above-described matter, and an object of the present invention is to provide a lower structure of a driver's compartment or a method for determining pedal slant angles which can properly shorten the period of the pressing change between the acceleration and brake pedals with a simple structure.

According to the present invention, there is provided a lower structure of a driver's compartment of a vehicle, comprising an acceleration pedal to be pressed by an operational foot of a driver seated in a driver's seat, the acceleration pedal having a pressing face which is to be pressed by the operational foot and formed to slant such that a front portion thereof is positioned at a higher level than a rear portion thereof, a brake pedal to be pressed by the operational foot of the driver, the brake pedal having a pressing face which is to be pressed by the operational foot and formed to slant such that a front portion thereof is positioned at a higher level than a rear portion thereof, and a floor portion on which a heel portion of the operational foot of the driver is placed, wherein the pressing face of the acceleration pedal is located in front of the pressing face of the brake pedal, and a slant angle of the pressing face of the acceleration pedal relative to a horizontal face is different from a slant angle of the pressing face of the brake pedal relative to the horizontal face in a side view.

According to the present invention, since the pressing face of the acceleration pedal is located in front of the pressing face of the brake pedal, it can be avoided that the both pedals are pressed concurrently, and the driver can operate the acceleration pedal which may be used more often in a driver's normal (comfortable) driving position with a properly stretched ankle.

Further, since the slant angle of the pressing face of the acceleration pedal relative to the horizontal face is different from the slant angle of the pressing face of the brake pedal relative to the horizontal face in the side view, the driver can press the pressing faces more properly, reducing the move amount of the driver's heel portion, compared to a case in which the respective pressing faces of these pedals are arranged in parallel to each other longitudinally. Specifically, in the case in which the respective pressing faces of the acceleration and bake pedals are arranged in parallel to each other longitudinally, the driver may be required to move the operational foot longitudinally in order to properly press the pressing faces of the pedals, maintaining the bending angle of the driver's ankle within an appropriate range. Meanwhile, in the case in which the slant angles of the pressing faces of the pedals are different from each other like the present invention, the driver can properly press the pressing faces of the pedals, maintaining the bending angle of the driver's ankle within an appropriate range, without improperly moving the driver's heel portion longitudinally.

According to an embodiment of the present invention, the acceleration and brake pedals are comprised of a hanging type of pedal in which an upper end thereof is pivotally supported such that the pedal swings around the upper end, a slant angle, relative to the horizontal face, of an imaginary tangential line of the pressing face of the acceleration pedal which passes through a specified heel-placing point on the floor portion which is located at the center between the acceleration pedal and the brake pedal in a vehicle width direction is set to be smaller than a slant angle, relative to the horizontal face, of an imaginary tangential line of the pressing face of the brake pedal which passes through the specified heel-placing point on the floor portion in the side view. Thereby, the driver can properly press the pressing faces of the acceleration and brake pedals with a foot's ball of the operational foot of the driver in a direction perpendicular to the imaginary tangential lines, i.e., in a right-angle direction relative to the pressing faces, maintaining the bending angle of the driver's ankle within the appropriate range, without improperly moving the driver's heel portion longitudinally. Accordingly, the both pedals can be operated (pressed) efficiently.

According to another embodiment of the present invention, a distance between a contact point of the imaginary tangential line of the pressing face of the acceleration pedal with the pressing face of the acceleration pedal and the specified heel-placing point is set to be equal to a distance between a contact point of the imaginary tangential line of the pressing face of the brake pedal with the pressing face of the brake pedal and the specified heel-placing point. Thereby, the driver can press the pressing faces of the pedals in a state in which the heel portion is fixed at the specified heel-placing point, so that the pressing change between the acceleration and brake pedals can be conducted easily and quickly during the properly short period.

According to another embodiment of the present invention, the acceleration pedal is comprised of an organ type of pedal in which a lower end thereof is pivotally supported such that the pedal swings around the lower upper end, and the pressing face of the acceleration pedal is formed in a substantially flat shape, the brake pedal is comprised of a hanging type of pedal in which an upper end thereof is pivotally supported such that the pedal swings around the upper end, and the slant angle of the pressing face of the acceleration pedal relative to the horizontal face is set to be greater than a slant angle, relative to the horizontal face, of an imaginary tangential line of the pressing face of the brake pedal which passes through a specified heel-placing point on the floor portion which is located at the center between the acceleration pedal and the brake pedal in a vehicle width direction in the side view. Thereby, the hinging type of brake pedal can be properly pressed with the foot's ball in the direction perpendicular to the imaginary tangential line, i.e., in the right-angle direction relative to the pressing faces, and the organ type of acceleration pedal can be properly pressed with the foot's ball and a portion from the foot's ball to the toe portion. Accordingly, the driver can operate (press) the both pedals efficiently.

According to another embodiment of the present invention, the acceleration pedal is configured such that an originally-set slant angle thereof in the side view is a specified angle within a range of 10-16 degrees steeper than a slant angle of an imaginary basic line which passes through the specified heel-placing point on the floor portion and a specified point on the pressing face of the acceleration pedal which has a specified distance from the specified heel-placing point on the floor portion which is equal to a distance between a contact point of the imaginary tangential line of the pressing face of the brake pedal with the pressing face of the brake pedal and the specified heel-placing point. Thereby, the driver can press the pressing faces of the pedals with an appropriate angle of toes in the state in which the heel portion is fixed at the specified heel-placing point, so that the pressing change between the acceleration and brake pedals can be conducted easily and quickly during the properly short period.

According to another embodiment of the present invention, the floor portion includes a slant floor portion which is provided in a specified area where the heel portion of the operational foot of the driver is placed and formed to slant such that a front portion thereof is positioned at a higher level than a rear portion thereof. Thereby, the driver can adjust the distance between the pressing face and the heel portion in accordance with the driver's height or the like, so that the appropriate pedal operation can be provided to any one of the drivers having different heights.

According to another embodiment of the present invention, the slant floor portion is configured such that a heel portion of a driver having an average height who is seated in the driver's seat in a normal position is placed onto a specified point on the slant floor portion which is located in back of the center, in a vehicle longitudinal direction, of the slant floor portion. In general, a driver having a tall height and a long sole's length of the operational foot can press the pedals properly by moving back the heel portion of the operational foot so as to keep a sufficiently long distance between the heel portion and the acceleration and brake pedals. Meanwhile, a driver having a short height and a short sole's length of the operational foot can press the pedals properly by moving forward the heel portion of the operational foot so as to get a properly short distance between the heel portion and the acceleration and brake pedals. Herein, the mount of moving forward the heel portion is generally relatively small compared to the amount of moving back the heel portion. Accordingly, in a case in which the sufficient amount of moving forward the heel portion cannot be obtained, the driver may have to operate the pedals in a state in which the heel portion is off (away from) the floor portion. Therefore, according to the above-described embodiment, it can be surely avoided that the short driver has to operate the pedals with the driver's heel portion off the floor portion.

According to another aspect of the present invention, there is a provided a method for determining pedal slant angles of the hanging type of acceleration and brake pedals of plural kinds of vehicle which have different levels of a sitting point of a driver's seat from the floor portion, wherein the respective pedal slant angles of the acceleration and brake pedals of the plural kinds of vehicle are set such that the respective slant angles, relative to the horizontal face, of the imaginary tangential lines of the acceleration and brake pedals of the vehicle having a higher level of the sitting point of the driver's seat from the floor portion are relatively small compared to the respective slant angles, relative to the horizontal face, of the acceleration and brake pedals of the vehicle having a lower level of the sitting point of the driver's seat from the floor portion.

In general, if the level of the sitting point of the driver's seat from the floor portion, i.e., the level of a so-called driver's hip point, is too high, the angle of the ankle relative to the horizontal face becomes small in a case in which the bending angle of the ankle is constant. Therefore, according to the above-described method, the respective slant angles, relative to the horizontal face, of the acceleration and brake pedals are set to be smaller for the vehicle having the higher hip point, so that the ankle's angle can be set at an appropriate angle uniformly regardless of the kinds of vehicle.

According to an embodiment of the above-described method, the pedal slant angles of the acceleration pedals of the plural kinds of vehicle are set such that in a case in which a difference in the level of the sitting point of the driver's seat from the floor portion between or among the plural kinds of vehicle is within a specified range, the respective slant angles, relative to the horizontal face, of the imaginary tangential lines of the acceleration pedals of the plural kinds of vehicle are set at an identical angle regardless of the difference in the level between or among the plural kinds of vehicle. It has been found that if the level of the sitting point of the driver's seat from the floor portion is within a predetermined basic range, a change of this level can be absorbed by adjusting an angle of the driver's knee and thereby it is unnecessary to change the ankle's angle in the above-described method. Therefore, according to this embodiment of the method of the present invention, the angle of the driver's ankle can be an appropriate angle, and also the acceleration pedals of the different kinds of vehicle having the different hip points can be made common, thereby be advantageous in costs.

According to further another aspect of the present invention, there is provided a method for determining pedal slant angles of the organ type of acceleration pedal and the hanging type of brake pedal of plural kinds of vehicle which have different levels of a sitting point of a driver's seat from the floor portion, wherein the respective pedal slant angles of the acceleration and brake pedals of the plural kinds of vehicle are set such that the slant angle of the pressing face of the acceleration pedal relative to the horizontal face and the slant angle, relative to the horizontal face, of the imaginary tangential line of the brake pedal of the vehicle having a higher level of the sitting point of the driver's seat from the floor portion are relatively small, respectively, compared to the slant angle of the pressing face of the acceleration pedal relative to the horizontal face and the slant angle, relative to the horizontal face, of the imaginary tangential line of the brake pedal of the vehicle having a lower level of the sitting point of the driver's seat from the floor portion.

As described above, if the level of the sitting point of the driver's seat from the floor portion, i.e., the level of the driver's hip point, is too high, the angle of the ankle relative to the horizontal face becomes small in the case in which the bending angle of the ankle is constant. Therefore, likewise, according to the above-described embodiment of the method, the respective slant angles, relative to the horizontal face, of the acceleration and brake pedals are set to be smaller for the vehicle having the higher hip point, so that the ankle's angle can be set at the appropriate angle uniformly regardless of the kinds of vehicle.

According to an embodiment of the above-described method, the pedal slant angles of the acceleration pedals of the plural kinds of vehicle are set such that in a case in which a difference in the level of the sitting point of the driver's seat from the floor portion between or among the plural kinds of vehicle is within a specified range, the respective slant angles of the pressing faces of the acceleration pedals of the plural kinds of vehicle relative to the horizontal face are set at an identical angle regardless of the difference in the level between or among the plural kinds of vehicle. Thereby, likewise, the angle of the driver's ankle can be the appropriate angle, and also the acceleration pedals of the different kinds of vehicle having the different hip points can be made common, thereby be advantageous in costs.

Other features, aspects, and advantages of the present invention will become apparent from the following description which refers to the accompanying drawings.

### BRIEF DESCRIPTION OF THE DRAWINGS

FIG. 1 is a schematic side view showing a lower structure of a driver's compartment according to a first embodiment of the present invention.

FIG. 2 is an enlarged schematic side view showing an acceleration pedal of FIG. 1 and its surrounding.

FIG. 3 is a schematic upper face view, which corresponds to FIG. 2.

FIG. 4 is an explanatory diagram of a normal (comfortable) position of a driver.

FIG. 5 is a diagram showing relationships between a level of a hip point and an angle of an ankle.

FIG. 6 is a diagram showing relationships between the level of the hip point and an appropriate angle of the acceleration pedal.

FIG. 7 is an enlarged schematic side view showing the acceleration pedal and its surrounding in the lower structure of a vehicle equipped with a slant floor portion.

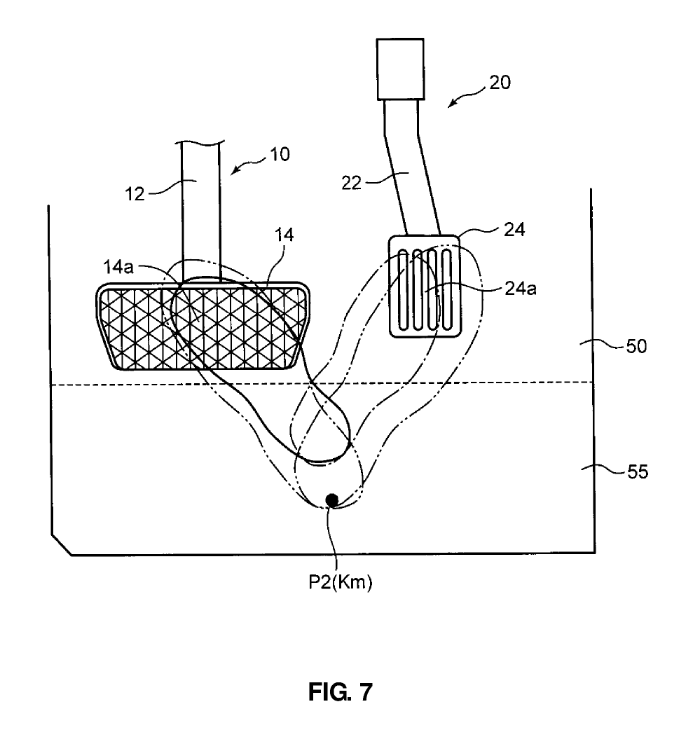

FIG. 8 is a schematic side view, which corresponds to FIG. 7.

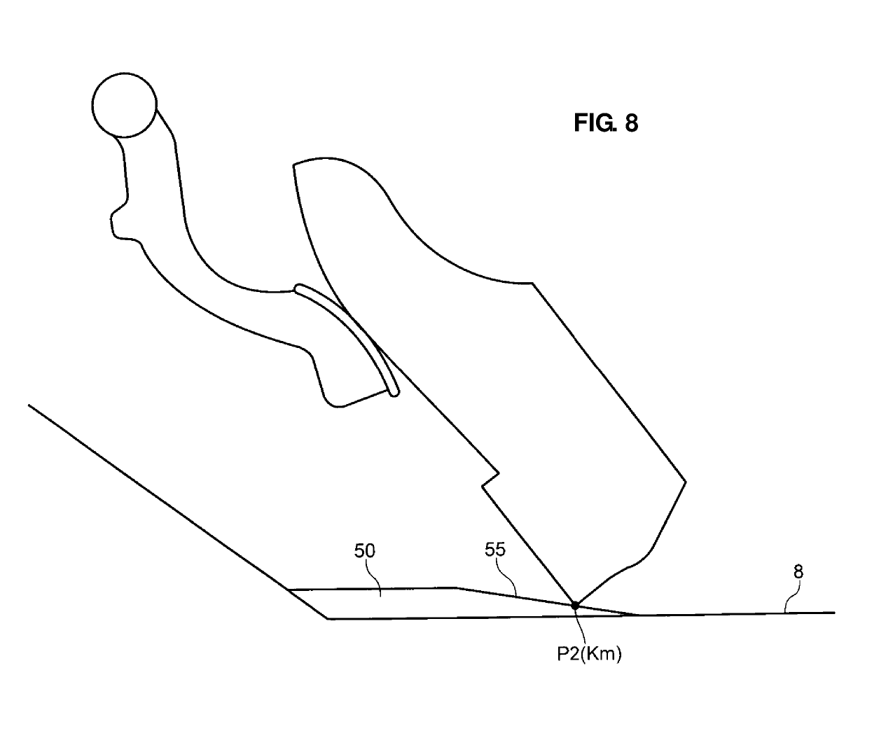

FIG. 9 is an enlarged schematic side view showing an acceleration pedal and its surrounding in a lower structure of a driver's compartment according to a second embodiment of the present invention.

FIG. 10 is a schematic upper face view, which corresponds to FIG. 9.

### DETAILED DESCRIPTION OF THE INVENTION

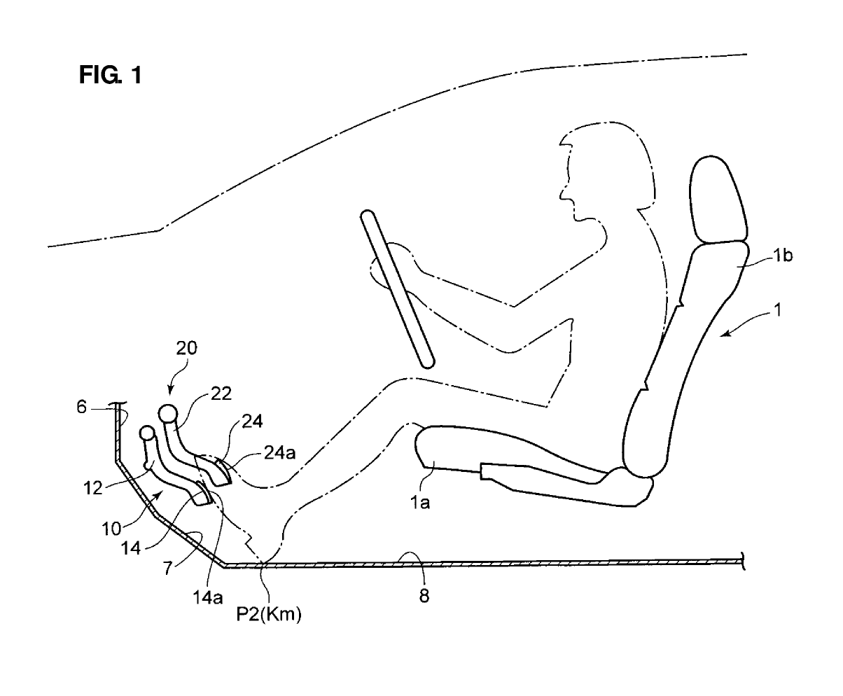

A first embodiment of a lower structure of a driver's compartment of an automotive vehicle according to the present invention will be described referring to FIGS. 1 through 4.

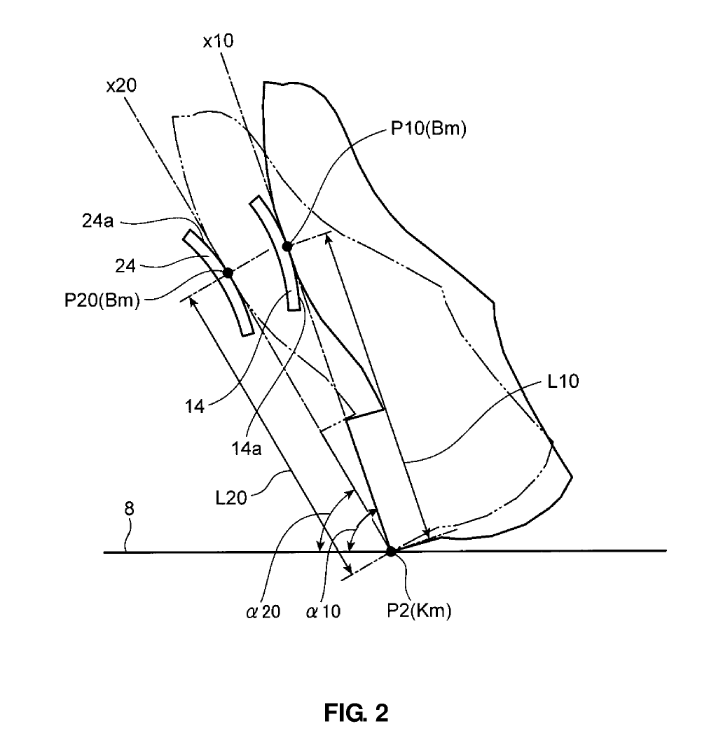

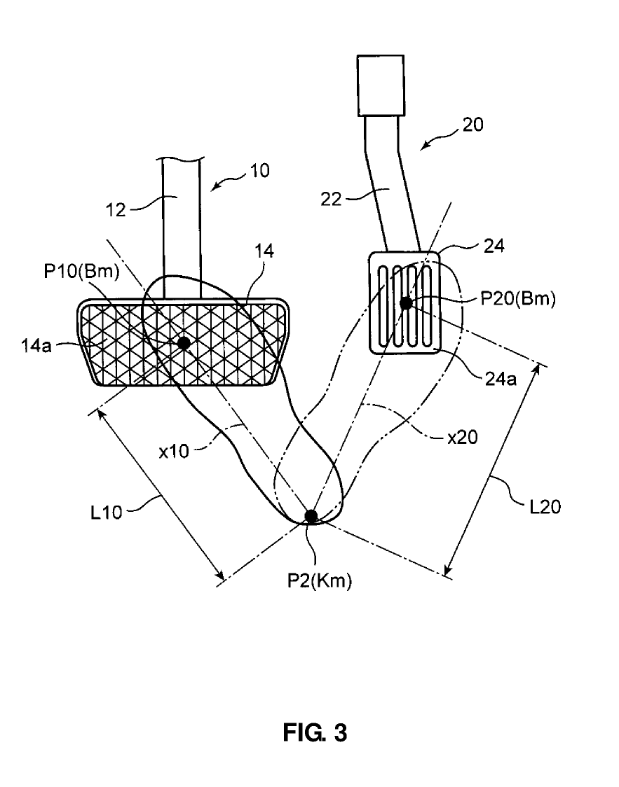

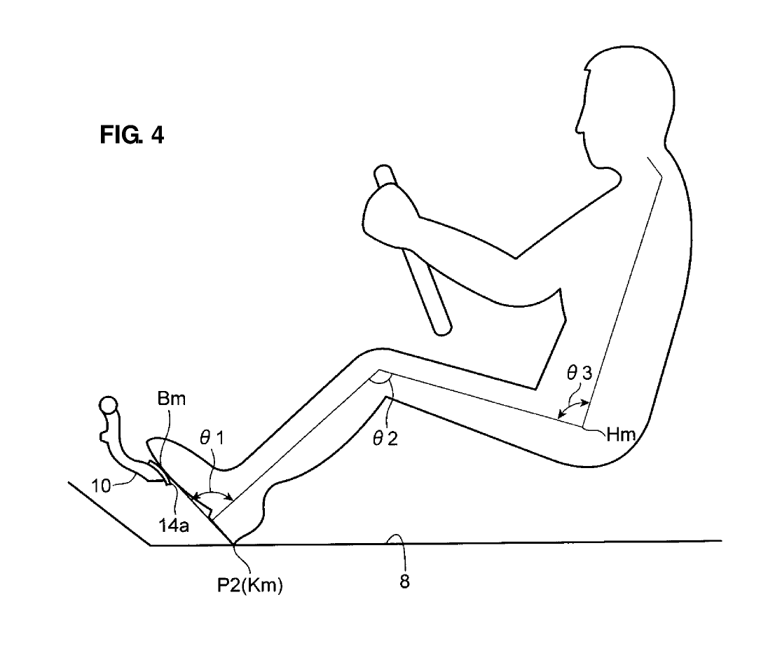

FIGS. 1 and 4 are a schematic side view and a diagram, respectively, which show a structure around a driver's seat according to the first embodiment. FIG. 2 is a partially-enlarged schematic side view of FIG. 1. FIG. 3 is a schematic upper face view, which corresponds to FIG. 2. Hereinafter, a vehicle longitudinal direction will be referred to as a longitudinal direction, and a vehicle width direction will be referred to as a lateral direction.

As shown in FIG. 1, at the vehicle body of the automotive vehicle are provided a dash panel 6 which partitions an engine room from a vehicle compartment, a kick up portion 7 which slants rearwardly and downwardly from a lower end portion of the dash panel 6, and a substantially flat floor portion 8 which extends rearwardly from a rear end portion of the kick up portion 7. A driver's seat 1 is provided behind the dash panel 6 and on the floor portion 8. The driver's seat 1 comprises a seat cushion 1a which forms a sitting portion of the driver and a seatback 1b which forms a back support of the driver.

A pair of operational pedals, a brake pedal 10 and an acceleration pedal 20, which the driver seated in the driver's seat 1 operates through pressing with the driver's operational foot is arranged side by side between the dash panel 6 and the driver's seat 1 at a front portion in the vehicle compartment.

The brake and acceleration pedals 10, 20 are respectively comprised of a hanging type of pedal in which an upper end thereof is pivotally supported such that the pedal swings around the upper end. The respective pedals 10, 20 comprise support portions 12, 22 which extend downwardly from the upper-end pivotal point and operated portions 14, 24 which are provided at respective lower ends the support portions 12, 22 and pressed by the driver's operational foot. The operated portions 14, 24 have respective pressing faces 14a, 24a which face the diver's sole. The pressing faces 14a, 24a are formed to curve and protrude obliquely rearwardly and upwardly so that the driver can press these faces 14a, 24a with a ball Bm of the driver's operational foot. That is, it is known that the pedal pressing operation by using the ball Bm of the driver's operational foot is the best for the hanging type of pedal. Therefore, according to the present embodiment, the pressing faces 14a, 24a are formed to protrude toward the operational foot so that the foot's ball Bm can properly contact the respective pressing faces 14a, 24a.

Herein, respective positions, in the longitudinal direction, of the pressing face 14a of the brake pedal 10 and the pressing face 24a of the acceleration pedal 20 are different from each other so that a situation in which the driver presses both of the pressing faces 14a, 24a concurrently can be avoided surely. In general, the acceleration pedal 20 is operated more often than the brake pedal 10. Therefore, in the present structure, the pressing face 24a of the acceleration pedal 20 is located in front of the pressing face 14a of the brake pedal 10 so that the driver can operate the acceleration pedal 20 in a normal position with a properly small angle of the driver's ankle.

Further, as shown in FIGS. 2 and 3, the pressing face 14a of the brake pedal 10 and the pressing face 24a of the acceleration pedal 20 are arranged such that distances L10, L20 between contact points P10, P20 of respective imaginary tangential lines x10, x20 with the pressing faces 14a, 24a and a specified heel-placing point P2 on the floor portion 8 which is located at the center between the brake pedal 10 and the acceleration pedal 20 in the lateral direction are identical to each other. Herein, the above-described imaginary tangential lines x10, x20 of the pressing faces 14a, 24a of the brake and acceleration pedals 10, 20 pass through the above-described specified heel-placing point P2, respectively. Reference characters L10, L20 shown in the side view of FIG. 2 and the upper face view of FIG. 3 denote respective projected lengths (distance) between the contact points P10, P20 and the specified heel-placing point P2.

As described above, the pressing face 24a of the acceleration pedal 20 is located in front of the pressing face 14a of the brake pedal 10. Accordingly, in accordance with the situation in which the distance L10 between the contact point P10 of the imaginary tangential line x10 with the pressing face 14a of the brake pedal 10 and the specified heel-placing point P2 is identical to the distance L20 between the contact point P20 of the imaginary tangential line x20 with the pressing face 24a of the acceleration pedal 20 and the specified heel-placing point P2, a slant angle of the pressing face 24a of the acceleration pedal 20 relative to a horizontal face in the side view, i.e., a slant angle α20 of the imaginary tangential line x20 of the acceleration pedal 20 relative to the horizontal face in the side view is smaller than a slant angle of the pressing face 14a of the brake pedal 10 relative to the horizontal face in the side view, i.e., a slant angle α10 of the imaginary tangential line x10 of the brake pedal 10 relative to the horizontal face in the side view.

In the present embodiment, the above-described heel-placing point P2 is set at a position where the heel portion of the driver having an average height who is seated in the driver's seat 1 in a normal position is placed. This driver having the average height may be considered as an American male driver who is 173 cm tall.

Herein, the above-described normal position means a driver's position which can provide the driver with a lasting and comfortable sitting position as well as a driving position for appropriate operations of a handle (driving wheel), the pedals and others. Specifically, as shown in FIG. 4, this normal position may be described as a driver's position having a bending angle of the ankle of the driver's operational foot, i.e., an ankle's angle θ1 of about 85-95°, a knee angle θ2 of about 115-135°, and a bending angle θ3 between an upper body and a thigh portion of about 95°.

Further, in the present embodiment, the distance L10 between the contact point P10 of imaginary tangential line x10 of the brake pedal with the pressing face 14a of the brake pedal and the specified heel-placing point P2 and the distance L20 between the contact point P20 of imaginary tangential line x20 of the brake pedal with the pressing face 24a of the brake pedal and the specified heel-placing point P2 are set at a length (18 cm) between a heel portion Km and a foot's ball Bm of the driver having the average height. And, a distance in the longitudinal direction between the above-described contact points P10, P20, i.e., a distance in the longitudinal direction between the position of the foot's ball Bm placed on the acceleration pedal 20 and the position of the foot's ball Bm placed on the brake pedal 10, is set at 35-55 mm. Moreover, in accordance with this, a difference between the slant angle α20 of the imaginary tangential line x20 of the acceleration pedal 20 relative to the horizontal face in the side view and the slant angle α10 of the imaginary tangential line x10 of the brake pedal 10 relative to the horizontal face in the side view is set to be smaller than 10°.

According to the lower structure of the driver's compartment of the vehicle according to the present embodiment described above, the pressing face 24a of the acceleration pedal is located in front of the pressing face 14a of the brake pedal. Accordingly, it can be avoided that the both pressing faces 14a, 24a of the pedals are pressed concurrently. Moreover, both the distance L10 between the contact point P10 of imaginary tangential line x10 of the brake pedal with the pressing face 14a of the brake pedal and the specified heel-placing point P2 and the distance L20 between the contact point P20 of imaginary tangential line x20 of the acceleration pedal 20 with the pressing face 24a of the acceleration pedal 20 and the specified heel-placing point P2 are set at the length between the heel portion Km and the foot's ball Bm of the driver having the average height, and the slant angle α20 of the imaginary tangential line x20 of the acceleration pedal 20 relative to the horizontal face in the side view is set to be smaller than the slant angle α10 of the imaginary tangential line x10 of the brake pedal 10 relative to the horizontal face in the side view. Accordingly, the driver, particularly the driver having the average height, can properly operate by pressing the pressing faces 14a, 24a with the foot's ball Bm in the state in which the heel portion Km is placed at the above-described heel-placing point P2. That is, it may be unnecessary that the driver moves the heel portion Km when conducting the pressing change between the pedals 10, 20, so that the period of this pedal pressing change can be properly shortened. Accordingly, the pedals 10, 20 can be properly operated at appropriate timing, so that both the pedal operation and the driving safety can improve. Further, the driver can properly press the pressing faces 14a, 24a of the acceleration and brake pedals 10, 20 with the foot's ball Bm in the direction perpendicular to the imaginary tangential lines x10, x20, i.e., in the right-angle direction relative to the pressing faces 14a, 24a, so that the operational force can be efficiently transmitted to the pedals 10, 20, thereby operating the pedals 10, 20 efficiently.

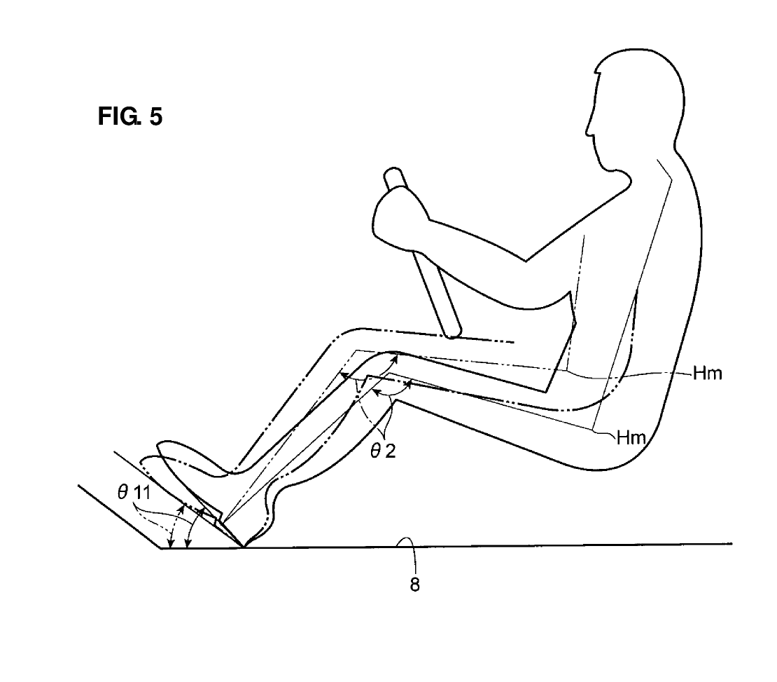

Herein, if the ankle's angle θ1 is constant, as shown in FIG. 5, when the level of the seat cushion 1a of the driver's seat 1 from the floor portion 8, i.e., the level of the hip point Hm of the driver, is set to be higher, the angle θ11 of the sole relative to the horizontal face becomes smaller. Therefore, it may be preferable that the slant angles of the pedals 10, 20 relative to the horizontal face be adjustable (changeable) in accordance with the level of the hip point Hm in order to maintain the ankle's angle θ1 at about 85-95° which can provide the above-described normal position to the driver. That is, it may be preferable that the slant angles of the respective pedals 10, 20 be changed for each of the plural kinds of vehicle having different levels of the hip point Hm. Specifically, it may be preferable that the slant angles of the peals 10, 20 of the vehicle having a higher level of the hip point Hm be set to be relatively small compared to the slant angles of pedals 10, 20 of the vehicle having a lower level of the hip point Hm. Thereby, the driver's position can be the above-described appropriate normal position regardless of the kinds of vehicle.

Further, the above-described hip point Hm may be changeable together with the change of the vertical position of the seat cushion 1a which is conducted in accordance with the driver's height even in the identical vehicle. Accordingly, the slant angles of the pedals 10, 20 may be configured to be changeable in accordance with the vertical position of the seat cushion 1a.

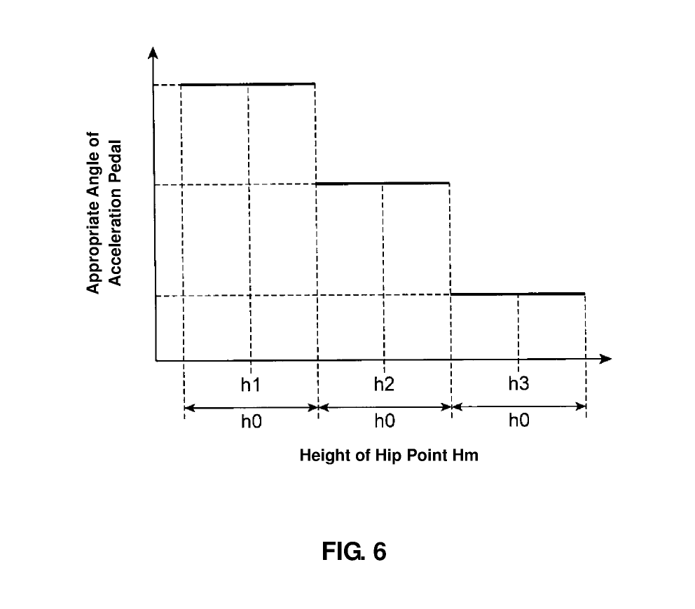

Herein, there is a problem in that providing a mechanism to change the slant angles of the pedals 10, 20 for the different kinds of vehicle may be costly. The inventors of the present invention investigated the appropriate pedal angles for each level of the hip point Hm. Then, they found that the appropriate pedal angles of the acceleration pedal 10 can be identical if the difference in vertical position of the hip points Hm falls within a specified range as shown in FIG. 6. The axis of abscissas shows the level of the hip point Hm and the axis of ordinates shows the appropriate angle of the acceleration pedal 20 in FIG. 6. This appropriate angle of the acceleration pedal 20, which is the slant angle of the imaginary tangential line x20 of the acceleration pedal 20 relative to the horizontal face, can allow the driver to press the pressing face 24a of the acceleration pedal with an appropriate pressing force. As shown in FIG. 6, when the level difference of the hip point Hm is within a basic range h0 with its center of the basic levels h1, n2, h3, the appropriate angles of the acceleration pedal 20 become identical. The basic range h0 is about 30 mm, for example, and the change amount of appropriate angles in accordance with the basic levels h1, h2, h3 is about 4°, for example. The basic range h0 is common (identical) regardless of the basic levels h1, h2, h3 in FIG. 6, but this basic range h0 may be set differently for the basic levels h1, h2, h3.

Therefore, it may be preferable that when the level difference of the hip point Hm is within the basic range h0, the slant angles of the respective pedals 10, 20 be set at an identical angle regardless of the plural kinds of vehicle having the different levels of the hip point Hm, which can ensure the appropriate pressing force and provide the common structure of the pedals.

Herein, the reason why the appropriate pressing force is ensured without changing the slant angles of the pedals 10, 20 even when the level of the hip point Hm changes as described above is that the level change may be absorbed by changing of the knee's angle. That is, the knee's angle θ2 has a wider allowable range (where the driver can take the above-described normal position) than the ankle's angle θ1 does, so that even if the knee's angle θ2 is changed in accordance with the level of the hip point Hm in the state in which the knee's angle θ1 is maintained at the appropriate angle and thereby the appropriate pressing force is ensured, this knee's angle θ2 may be kept properly within the allowable range.

While the above-described heel-placing point P2 is set at a point where the heel portion of the driver having the average height in the above-described normal position is placed according to the present embodiment, this point P2 may be a point on which a heel portion of another driver having a different height from the average height is placed. Meanwhile, a slant floor portion 50 may be provided at the floor portion 8 so that the specified heel-placing point P2 is set for the driver having the average height and the operation of the pedals can be ensured for the other drivers as well. Specifically, the slant floor portion 50 is provided in back of the brake pedal 10 and the acceleration pedal 20 and includes a slant face 55 which is formed to slant such that its front portion is positioned at a higher level than its rear portion.

In a case in which the above-described slant floor portion 50 is provided, a shorter driver places the heel portion Km at a specified point of the slant floor portion 50 which is located forwardly and upwardly from the above-described heel-placing point P2, thereby properly pressing the pedals 10, 20 with a shortened distance between the hell and the pedals 10, 20. Meanwhile, a taller driver places the heel portion Km at another specified point of the slant floor portion 50 which is located rearwardly and downwardly from the above-described heel-placing point P2, thereby properly pressing the pedals 10, 20 with a properly long distance between the hell and the pedals 10, 20. Herein, in general, the height of the driver is within a range of about 150-190 cm, and the above-described average height of 173 cm is higher than a central value of this height range. Accordingly, it may be preferable that the above-described heel-placing point P2 of the heel portion of the driver having the average height be located in back of the center, in the longitudinal direction, of the slant floor portion 50. Further, an allowable distance of the heel portion which the driver can move forwardly for the pedals 10, 20 is smaller than that of the heel portion which the driver can move back for the pedals 10, 20, and the tall driver having a long sole's length of the operational foot can press the pedals properly by moving back the heel portion so as to keep a sufficiently long distance between the heel portion and the pedals, but the short driver having a short sole's length of the operational foot may need to press the pedals with the heel portion being off the floor portion 8 in a case in which the heel portion cannot be moved forwardly sufficiently. Therefore, for the reason of avoiding surely the situation in which the pressing operation of the pedals 10, 20 with the heel portion being off the floor portion 8 as well, it may be preferable that the heel-placing point P2 of the heel portion of the driver having the average height be located in back of the center, in the longitudinal direction, of the slant floor portion 50.

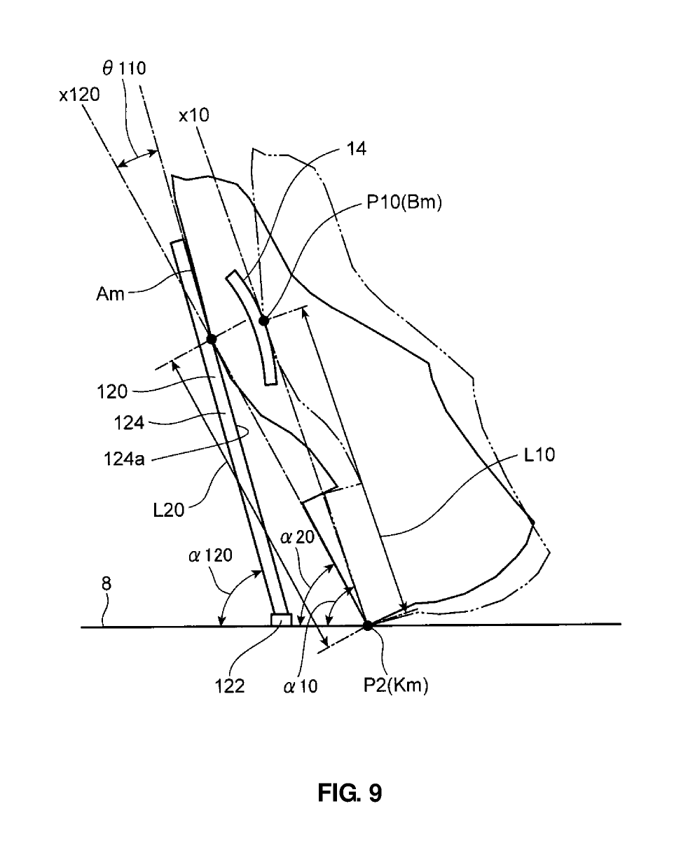

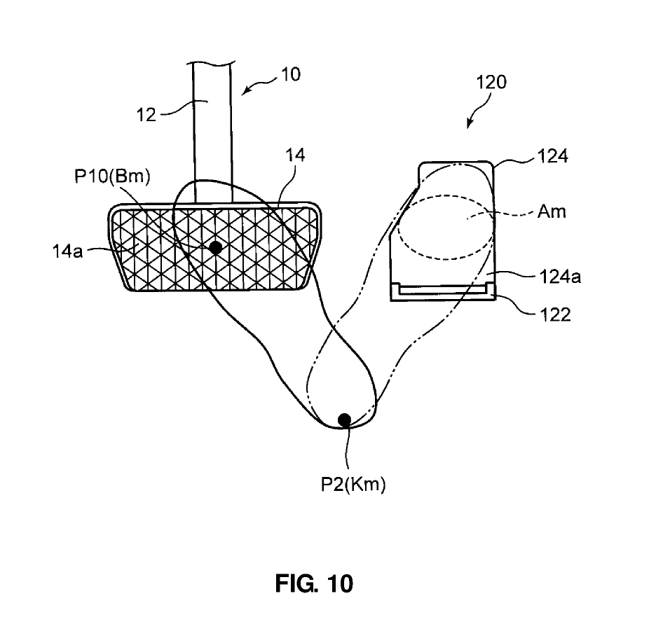

Next, a second embodiment of the lower structure of the driver's compartment of the vehicle according to the present invention will be described referring to FIGS. 9 and 10.

FIG. 9 is an enlarged schematic side view showing an acceleration pedal 120 and the brake pedal 10 and their surrounding, which corresponds to FIG. 2 for the first embodiment. FIG. 10 is a schematic upper view, which corresponds to FIG. 9.

The second embodiment adopts an organ type of acceleration pedal 120 in which its lower end hinge portion 122 is pivotally supported such that the pedal swings around the lower upper end hinge portion 122, in place of the hanging type of acceleration pedal 20 of the first embodiment.

The acceleration pedal 120 of the second embodiment includes an operated portion 124 which extends upwardly from the lower end hinge portion 122 and receives the pressing operation by the driver's operational foot. Specifically, this operated portion 124 is of a flat shape and extends obliquely forwardly and upwardly. The operated portion 124 has a flat-face-shaped pressing face 124a which faces the driver's sole.

It is known that the driver presses the organ type of acceleration pedal 120 with not only the foot's ball Bm but a whole part of a toe portion Am from the foot's ball Bm to toes, which is different from the hanging type of acceleration pedal.

The inventors also found that it may be preferable that in a case in which the driver presses the pedal with the toe portion Am of the shoes when the driver wears the normal shoes, an slant angle θ110 of the toe portion Am relative to a specified face which passes through the hoot's ball Bm and the heel portion Km (see FIG. 10) be 10° or greater and 16° or smaller. Specifically, when the driver wear no shoes, it may be preferable that the slant angle of the toe portion relative to the face passing through the hoot's ball Bm and the heel portion Km be 15° or greater and 21° or smaller. When the driver wears the normal shoes, meanwhile, the toe portion Am of the normal shoes inclines relative to the toe portion of the driver's sole by about 5°. Thus, it was found that it may be preferable that the slant angle θ110 of the toe portion Am relative to the face passing through the hoot's ball Bm and the heel portion Km be 10° or greater and 16° or smaller.

Accordingly, according to the present embodiment, as shown in FIG. 10, the acceleration pedal 120 is configured such that the pressing face 124a of the acceleration pedal 120 in its originally-set state slants to be steeper, by the above-described slant angle θ110 of the toe portion Am, than an imaginary line X120 which passes through the specified heel-placing point P2 and a specified portion of the pressing face 124a which has the same distance from the specified heel-placing point P2 as the distance between the specified heel-placing point P2 and a portion at the foot's ball Bm. Thereby, the ankle's angle can be made appropriate, so that the acceleration pedal 120 can be pressed properly with the toe portion Am and both the brake pedal 10 and the acceleration pedal 120 can be operated in the state in which the heel portion is placed onto the specified heel-placing point P2. The slant angle θ110 of the toe portion Am is set at 15°, for example.

The distance in the longitudinal direction between the position of the foot's ball Bm placed on the acceleration pedal 120 and the position of the foot's ball Bm placed on the brake pedal 10 is set at 35-55 mm similarly to the first embodiment. That is, the respective foot's balls Bm on the respective pedals 10 and 20, 120 are located at the same position in the first embodiment and the second embodiment.

Herein, since the positions of the foot's balls Bm on the respective pedals 10 and 20, 120 are identical in the first embodiment and the second embodiment as described above, the imaginary line x120 passing through the above-described heel-placing point P2 and the foot's ball Bm on the acceleration pedal 120 matches the imaginary tangential lien x20 of the acceleration pedal of the first embodiment. The structure of the brake pedal 10 is similar to the first embodiment, so that the imaginary tangential line x10 of the first embodiment matches the imaginary tangential line x10 of the second embodiment.

Further, in the case in which the distance in the longitudinal direction between the position of the foot's ball Bm placed on the acceleration pedal 20 and the position of the foot's ball Bm placed on the brake pedal 10 is set at 35-55 mm as described above, the difference between the slant angle α20 of the imaginary tangential line x20 of the acceleration pedal relative to the horizontal face and the slant angle α10 of the imaginary tangential line x10 of the brake pedal according to the first embodiment in the side view is smaller than 10°.

In the second embodiment, meanwhile, the angle difference between the pressing face 124a of the acceleration pedal 120 and the imaginary line x120 (the difference between α120 and α20) is the slant angle θ110 of the toe portion Am, and this angle is 10° or greater and 16° or smaller. Accordingly, in the second embodiment, the slant angle α120 of the pressing face 124a of the acceleration pedal 120 relative to the horizontal face is greater than the slant angle α10 of the imaginary tangential line x10 of the brake pedal relative to the horizontal face.

As described above, in the second embodiment as well as the first embodiment, the ankle's angle can be the appropriate angle, so that the acceleration pedal 120 can be pressed properly with the toe portion Am and both the brake pedal 10 and the acceleration pedal 120 can be operated in the state in which the driver places the heel portion onto the specified heel-placing point P2. Consequently, the operation and the driving safety can be improved.

Herein, the above-described slant floor portion 50 may be provided at the floor portion 8 in the second embodiment as well. Further, the slant angle of the acceleration pedal 120 may be changeable in accordance with the level of the hip point Hm.

The present invention should not be limited to the above-described embodiments, and any other modifications and improvements may be applied within the scope of a sprit of the present invention.

What is claimed is:

1. A lower structure of a driver's compartment of a vehicle, comprising:
an acceleration pedal to be pressed by an operational foot of a driver seated in a driver's seat, the acceleration pedal having a pressing face which is to be pressed by the operational foot and formed to slant such that a front portion thereof is positioned at a higher level than a rear portion thereof;
a brake pedal to be pressed by the operational foot of the driver, the brake pedal having a pressing face which is to be pressed by the operational foot and formed to slant such that a front portion thereof is positioned at a higher level than a rear portion thereof; and
a floor portion on which a heel portion of the operational foot of the driver is placed, wherein said pressing face of the acceleration pedal is located in front of said pressing face of the brake pedal, and a slant angle of the pressing face of the acceleration pedal relative to a horizontal surface of the floor portion is different from a slant angle of the pressing face of the brake pedal relative to the horizontal surface in a side view,
wherein said acceleration pedal is comprised of a pedal in which a lower end thereof is pivotally supported on the floor portion such that the pedal swings around the lower upper end, and said pressing face of the acceleration pedal is formed in a flat shape,
said brake pedal is comprised of a hanging type of pedal in which an upper end thereof is pivotally supported such that the pedal swings around the upper end, and
said slant angle of the pressing face of the acceleration pedal relative to the horizontal face is set to be greater than a slant angle, relative to the horizontal surface, of an imaginary tangential line of said pressing face of the brake pedal which passes through a specified heel placing point on the floor portion which is located at the center between the acceleration pedal and the brake pedal in a vehicle width direction in the side view.

2. The lower structure of a driver's compartment of a vehicle of claim 1, wherein said acceleration pedal is configured such that an originally-set slant angle thereof in the side view is a specified angle within a range of 10-16 degrees steeper than a slant angle of an imaginary basic line which passes through said specified heel-placing point on the floor portion and a specified point on said pressing face of the acceleration pedal which has a specified distance from the specified heel-placing point on the floor portion which is equal to a distance between a contact point of said imaginary tangential line of the pressing face of the brake pedal with said pressing face of the brake pedal and the specified heel-placing point.

3. The lower structure of a driver's compartment of a vehicle of claim 2, wherein a distance in the longitudinal direction between the specified point on said pressing face of the acceleration pedal and said contact point of said imaginary tangential line of the pressing face of the brake pedal is set within 35-55 mm.

4. A method for determining pedal slant angles of pedals of plural kinds of vehicle which are respectively equipped with a lower structure of a driver's compartment of a vehicle and have different levels of a sitting point of a driver's seat,
wherein said lower structure of a driver's compartment of a vehicle comprises:
an acceleration pedal to be pressed by an operational foot of a driver seated in the driver's seat, the acceleration pedal having a pressing face which is to be pressed by the operational foot and formed to slant such that a front portion thereof is positioned at a higher level than a rear portion thereof;
a brake pedal to be pressed by the operational foot of the driver, the brake pedal having a pressing face which is to be pressed by the operational foot and formed to slant such that a front portion thereof is positioned at a higher level than a rear portion thereof; and
a floor portion on which a heel portion of the operational foot of the driver is placed,
wherein said pressing face of the acceleration pedal is located in front of said pressing face of the brake pedal, and a slant angle of the pressing face of the acceleration pedal relative to a horizontal surface of the floor portion is different from a slant angle of the pressing face of the brake pedal relative to the horizontal surface in a side view,
said acceleration pedal is comprised of a pedal in which a lower end thereof is pivotally supported on the floor portion such that the pedal swings around the lower upper end, and said pressing face of the acceleration pedal is formed in a flat shape,
said brake pedal is comprised of a hanging type of pedal in which an upper end thereof is pivotally supported such that the pedal swings around the upper end,
said slant angle of the pressing face of the acceleration pedal relative to the horizontal surface is set to be greater than a slant angle, relative to the horizontal surface, of an imaginary tangential line of said pressing face of the brake pedal which passes through a specified heel-placing point on the floor portion which is located at the center between the acceleration pedal and the brake pedal in a vehicle width direction in the side view, and
in said method for determining pedal slant angles of pedals, the respective pedal slant angles of the acceleration and brake pedals of the plural kinds of vehicle are set such that said slant angle of the pressing face of the acceleration pedal relative to the horizontal surface and said slant angle, relative to the horizontal surface, of the imaginary tangential line of the brake pedal of the vehicle having a higher level of the sitting point of the driver's seat from the floor portion are relatively small, respectively, compared to said slant angle of the pressing face of the acceleration pedal relative to the horizontal surface and said slant angle, relative to the horizontal surface, of the imaginary tangential line of the brake pedal of the vehicle having a lower level of the sitting point of the driver's seat from the floor portion.

5. The method for determining pedal slant angles of claim 4, wherein the pedal slant angles of the acceleration pedals of the plural kinds of vehicle are set such that in a case in which a difference in the level of the sitting point of the driver's seat from the floor portion between or among the plural kinds of vehicle is within a specified range, the respective slant angles of the pressing faces of the acceleration pedals of the plural kinds of vehicle relative to the horizontal surface are set at an identical angle regardless of said difference in the level between or among the plural kinds of vehicle.
